(19) United States
(12) Patent Application Publication
(10) Pub. No.: US 2004/0095289 A1
(43) Pub. Date: May 20, 2004

(54) Multi-band helical antenna

(75) Inventors: Jung Bin Bae, Gwangju (KR); Jong Kyu Kim, Gyeonggi-do (KR); Jae Gun Lee, Gyeonggi-do (KR)

Correspondence Address: McGuireWoods, Suite 1800, 1750 Tysons Boulevard, McLean, VA, 22102-4215, US

(73) Assignee: Meerae Tech, Inc.

(21) Appl. No.: 10/612,093

(22) Filed: Jul. 3, 2003

(30) Foreign Application Priority Data
Jul. 4, 2002 (KR) 2002-38611
Jul. 4, 2002 (KR) 2002-38612
Jul. 4, 2002 (KR) 2002-38613

(51) Int. Cl. H01Q 1/36

(52) U.S. Cl. 343/895; 343/700 MS

(57) ABSTRACT

A multi-band helical antenna of the present invention includes a dielectric body including a plurality of dielectric sheets stacked in a predetermined order and a first and a second metallic pattern sections provided in the dielectric body. The first metallic pattern includes a plurality of first partially opened metallic loop patterns and a plurality of first connection elements connecting the respective adjacent first partially opened metallic loop patterns to form a first spiral structure. The second metallic pattern section includes a plurality of second partially opened metallic loop patterns and a plurality of second connection elements connecting the respective adjacent second partially opened metallic loop patterns to form a second spiral structure. The first and the second metallic pattern sections having different entire lengths. Accordingly, the multi-band helical antenna of the present invention has a dual resonant frequency characteristic and operates in different frequency bands.

### FIELD OF THE INVENTION

The present invention relates to an antenna for a mobile communications or radio communications terminal transmitting and receiving a radio frequency signal; and, more particularly, to a multi-band helical antenna capable of operating in multiple frequency bands by varying impedances thereof.

### BACKGROUND OF THE INVENTION

Recently, various mobile communications systems such as a cellular service system, PCS system, GMS system and Iridium service system using a satellite are available throughout the world. For example, in Korea, cellular service, PCS and CT-2 systems are commercially provided. Portable terminals used in the mobile communications systems have been developed and pushed for improvement in compactness, multifunction, lightweight and low power-consumption. An antenna functions to transmit and receive a signal between a terminal and a base station, and is a critical component determining communication quality of the terminal. Since performance of the antenna may vary depending on the shape and material of the terminal where the antenna is mounted, the antenna should be designed compatible with a model of the terminal in order to obtain an optimal performance thereof.

In general, for the purpose of bidirectional communications and convenient possession, a non-directional retractable antenna is used as an antenna for a terminal. An antenna of a commercially available terminal has a combined structure suitable for both a signal waiting state and a communications state to transmit and receive a linearly polarized signal with ease. There are largely two kinds of antennas, i.e., a helical antenna and a monopole antenna.

The helical antenna has a spiral configuration which protrudes from a top of the terminal and has an advantage in that it can communicate regardless of the orientation of the terminal.

The monopole antenna is used in an extended state for a high quality communication. The monopole antenna has a greater ability in a vertical orientation than the helical antenna, but theoretically cannot receive a signal in a horizontal orientation.

The performance of such an antenna depends on the shapes of the terminals on which it is mounted and a matching circuit is provided between the antenna and a duplex in order to compensate the difference in performance.

The helical antenna has a spiral structure with a physical resonant length of λ/2 and λ/4 which uses a connection element. The helical antenna also has a ground surface and an electric power supplying line.

In particular, a conventional helical antenna is a single band helical antenna implemented by using ceramic sheets of thickness of tens or hundreds of micrometer and forming a vertical via hole and a horizontal pattern in each of the sheets. The implemented antenna structurally exhibits a single band characteristic, and is therefore unable to operate in two or more different bands.

Specifically, the cellular service system and the PCS system use, e.g., 824˜894 MHz band and 1750˜1870 MHz band, respectively, with the center frequencies thereof spaced apart from each other by about 1 GHz, and the center frequencies are not in an integer time relationship with harmonics component thereof. Accordingly, the conventional antenna cannot be used in both the cellular service system and the PCS system using different frequency bands even though a matching circuit is employed thereto.

Attempts have been made to allow one terminal to operate in various communications systems using different frequency bands so that the terminal can be used throughout the world. In this case, the antenna and other components employed in such terminal for various communications systems should meet an electrical standard and operate in two or more frequency bands. The antenna should also be able to operate in next-generation mobile communications services such as IMT-2000 with a broader frequency band and in two or more different mobile communications service bands.

### SUMMARY OF THE INVENTION

It is, therefore, a primary object of the present invention to provide a multi-band helical antenna capable of operating in multiple frequency bands.

In accordance with an aspect of the present invention, there is provided a multi-band helical antenna comprising: a dielectric body including a plurality of dielectric sheets stacked in a predetermined order; and at least a first metallic pattern section and a second metallic pattern section provided in the dielectric body, the first metallic pattern including a plurality of first partially opened metallic loop patterns and a plurality of first connection elements connecting the respective adjacent first partially opened metallic loop patterns to form a first spiral structure, and the second metallic pattern section including a plurality of second partially opened metallic loop patterns and a plurality of second connection elements connecting the respective adjacent second partially opened metallic loop patterns to form a second spiral structure, the first and the second metallic pattern section having different entire lengths.

In accordance with another aspect of the present invention, there is provided a multi-band helical antenna comprising: a dielectric body including at least a plurality of first dielectric sheets of a first thickness t1 and a plurality of second dielectric sheets of a second thickness t2 that is different from t1, the dielectric sheets being stacked in a predetermined order; and at least a first metallic pattern section and a second metallic pattern section provided in the first dielectric sheets and the second dielectric sheets, respectively, the first metallic pattern section including a plurality of first partially opened metallic loop patterns spaced apart from each other by a first distance and a plurality of first connection elements connecting the respective adjacent first metallic loop patterns to form a first spiral structure, and the second metallic pattern section including a plurality of second partially opened metallic loop patterns spaced apart from each other by a second distance and a plurality of second connection elements connecting the respective adjacent second metallic loop patterns to form a first spiral structure.

In accordance with still another aspect of the present invention, there is provided a multi-band helical antenna comprising: a dielectric body including a plurality of dielectric sheets of a predetermined thickness, the dielectric sheets being stacked in a predetermined order; and at least a first metallic pattern section and a second metallic pattern section provided in the dielectric body, the first metallic pattern section including a plurality of first partially opened metallic loop patterns having a first radius r1 and a plurality of first connection elements connecting the respective adjacent first partially opened metallic loop patterns to form a first spiral structure, and the second metallic pattern section including a plurality of second partially opened metallic loop patterns having a second radius r2 that is different from r1 and a plurality of second connection elements connecting the respective adjacent second partially opened metallic loop patterns to form a second spiral structure.

In accordance with still another aspect of the present invention, there is provided a multi-band helical antenna comprising: a dielectric body including a plurality of dielectric sheets of a predetermined thickness, the dielectric sheets being stacked in a predetermined order; at least a first metallic pattern section and a second metallic pattern section provided in the dielectric body, the first metallic pattern section including a plurality of first partially opened metallic loop patterns having a first entire length l1 and a plurality of first connection elements connecting the respective adjacent first partially opened metallic loop patterns to form a first spiral structure, and the second metallic pattern section including a plurality of second partially opened metallic loop patterns having a second entire length l2 different from l1 and a plurality of second connection elements connecting the respective adjacent second partially opened metallic loop patterns to form a second spiral structure.

### BRIEF DESCRIPTION OF THE DRAWINGS

The above and other objects and features of the present invention will become apparent from the following description of preferred embodiments given in conjunction with the accompanying drawings in which:

FIG. 1 is a perspective view showing a multi-band helical antenna in accordance with a first embodiment of the present invention;

FIG. 2 is a perspective view showing metallic patterns of the multi-band helical antenna in accordance with the first embodiment of the present invention;

FIG. 3 is an exploded cross-sectional view of the stacked structure of the multi-band helical antenna;

FIGS. 4A and 4B are a top and a bottom views of the uppermost layer of dielectric sheet, respectively;

FIGS. 5A and 5B are a top and a bottom views of the intermediate or lower layers of dielectric sheet, respectively;

FIG. 6 is a perspective view showing a state in which the multi-band helical antenna in accordance with the present invention is mounted on a top of a terminal;

FIG. 7 is a perspective view showing a multi-band helical antenna in accordance with a second preferred embodiment of the present invention;

FIG. 8 is a perspective view showing metallic patterns of the multi-band helical antenna in accordance with the second preferred embodiment of the present invention;

FIGS. 9A and 9B are exploded cross-sectional views of the first metallic section 120 and the second metallic section 121, respectively;

FIGS. 10A and 10B are a top and a bottom views of the uppermost layer of dielectric sheet, respectively;

FIGS. 11A and 11B are a top and a bottom views of one of the intermediate or lower dielectric sheets, respectively;

FIG. 12 is a perspective view showing a multi-band helical antenna in accordance with a third embodiment of the present invention;

FIGS. 13A and 13B are perspective views showing metallic patterns of the multi-band helical antenna, respectively, in accordance with the third embodiment of the present invention;

FIG. 14 is a graph showing the dual resonant characteristic of the helical antenna in accordance with the third preferred embodiment of the present invention;

FIG. 15 is a graph showing a resonant characteristic in a wide band in accordance with the variation of the present invention;

FIG. 16 is an exploded cross-sectional view of the stacked structure of the multi-band helical antenna in accordance with the third embodiment;

FIGS. 17A and 17B are a top and a bottom views of the uppermost layer of dielectric sheet in accordance with the third embodiment, respectively;

FIGS. 18A and 18B are a top and a bottom views of the second layer of dielectric sheet, respectively; and

FIGS. 19A and 19B are a top and a bottom views of the third layer of dielectric sheet, respectively.

### DETAILED DESCRIPTION OF THE PREFERRED EMBODIMENTS

Preferred embodiments of the present invention will now be described in detail with reference to the accompanying drawings.

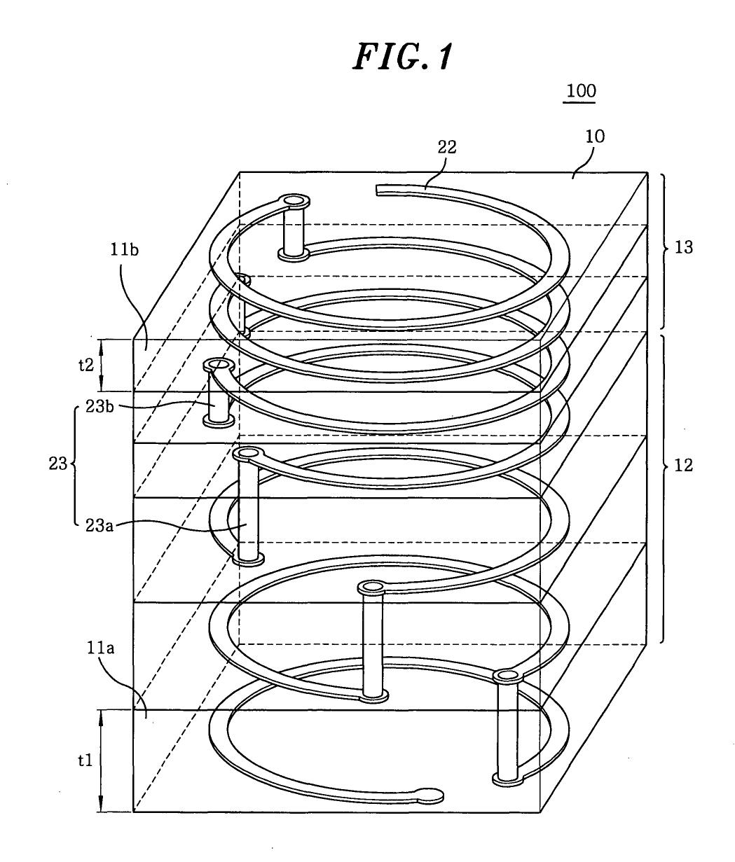

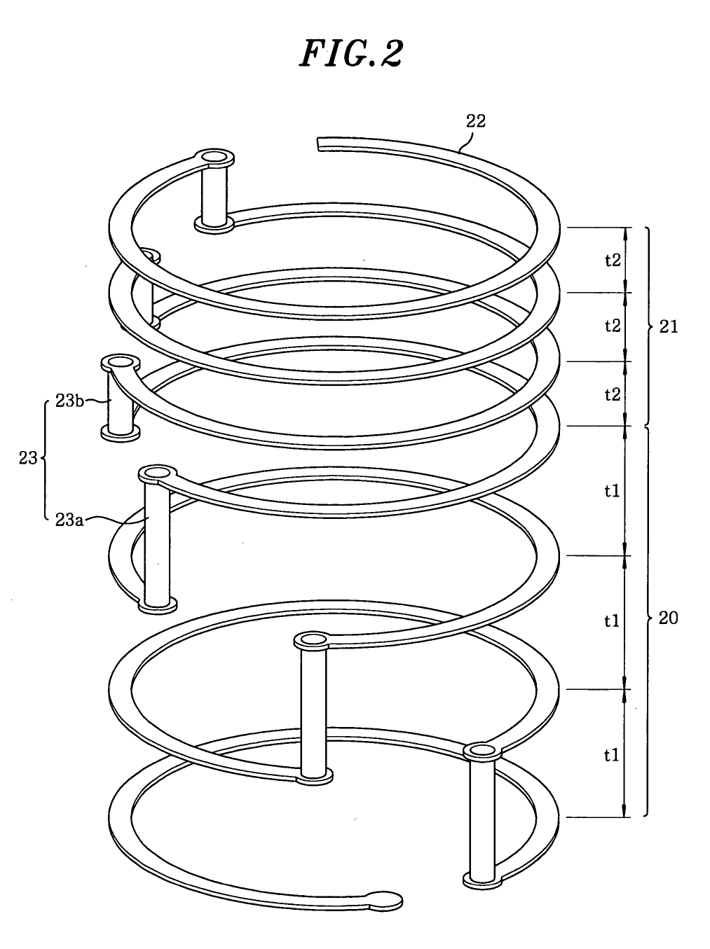

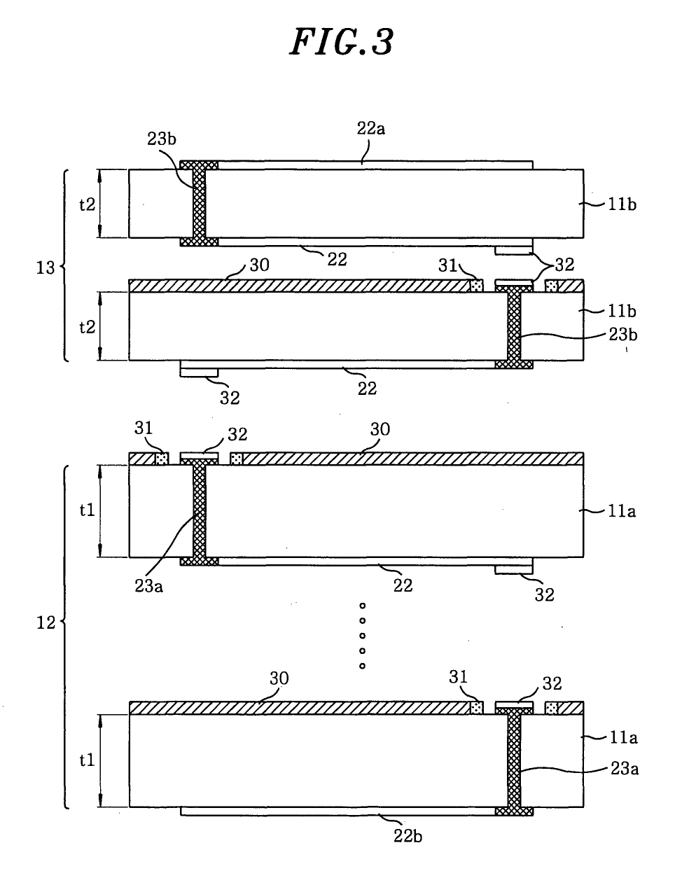

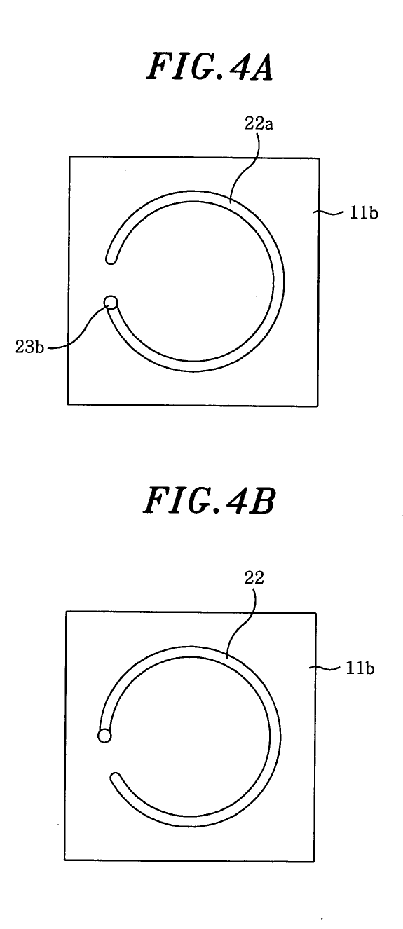

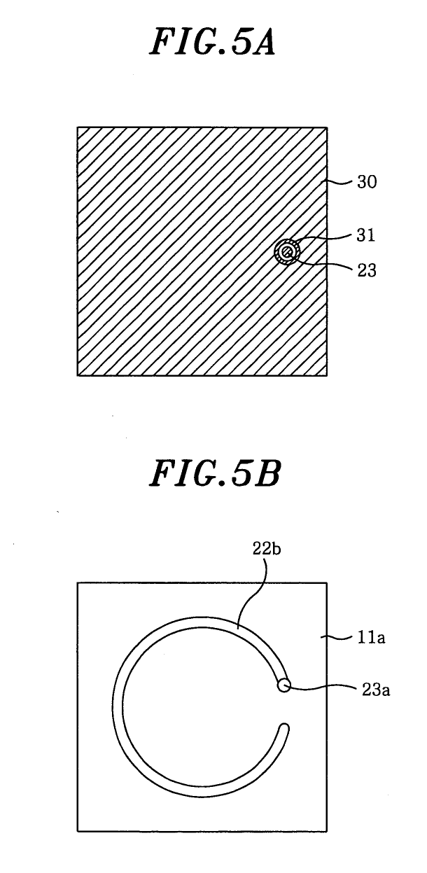

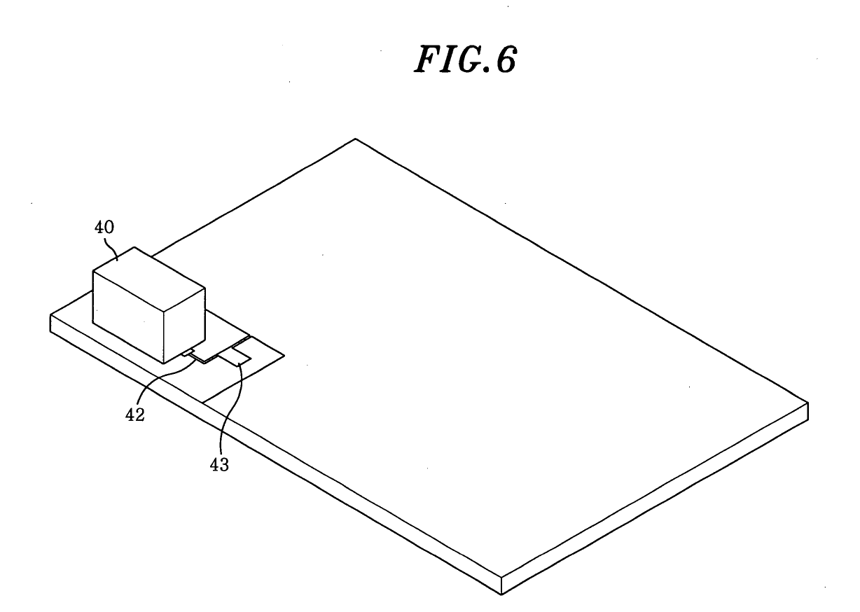

FIG. 1 is a perspective view showing a multi-band helical antenna in accordance with a first embodiment of the present invention, FIG. 2 is a perspective view showing metallic patterns of the multi-band helical antenna in accordance with the first embodiment of the present invention, FIG. 3 is an exploded cross-sectional view of a stacked structure of the multi-band helical antenna, and FIGS. 4A and 4B are a top and a bottom views of an uppermost layer of dielectric sheet, respectively. FIGS. 5A and 5B are a top and a bottom views of an intermediate or a lower layers of dielectric sheet, respectively, and FIG. 6 is a perspective view showing a state in which the multi-band helical antenna in accordance with the present invention is mounted on a top of a terminal.

Referring to FIGS. 1 and 2, the multi-band helical antenna of the present invention comprises a dielectric body 10 including a rectangular parallelepiped shape, and metallic pattern sections 20, 21 including a plurality of partially opened circular metallic loop patterns 22 and metallic connection elements 23 which perform helical antenna function.

The dielectric body 10 is constructed by stacking a plurality of dielectric sheets 11a of a first thickness t1 and a plurality of dielectric sheets 11b of a second thickness t2. Each of the metallic loop patterns 22 of the metallic pattern sections 20, 21 has an opening angle and each of the metallic connection elements 23 connects the adjacent metallic loop patterns 22 to form a spiral structure.

Since the length of the connection elements 23 in the metallic pattern section 20 is different from that in the metallic pattern section 21, the distance between the adjacent loop patterns 22 in the metallic pattern section 20 is different from that in the section 21, thereby allowing the helical antenna to have a dual band resonant characteristic.

In the multi-band helical antenna in accordance with the first preferred embodiment of the present invention, the first metallic pattern section 20 has the loop patterns 22 spaced apart from each other by a distance t1 and the second metallic pattern section 21 has the loop patterns 22 spaced apart from each other by a distance t2; therefore, the helical antenna has a dual resonant characteristic. The distances between the adjacent loop patterns 22 in the first and the second metallic pattern sections 20, 21 are determined by the thicknesses t1, t2 of the dielectric sheets 11a, 11b or the lengths t1, t2 of the first and the second connection elements 23a, 23b.

In the above embodiment, for simplification of explanation, two metallic pattern sections having the distances t1, t2 between the loop patterns 22, respectively, are shown; but the present invention is not limited thereto. It is appreciated that the helical antenna may have a multiple resonant characteristic by employing three or more pattern sections having different loop pattern distances.

Typically, the entire height of the dielectric body 10 of the helical antenna can be varied in accordance with the frequency being used, the length of metallic patterns, and the length of connection elements; and when used as a mobile communications antenna, the dielectric body 10 has a height of about 5˜15 mm.

For example, for use in a band of 1.8 GHz, the helical antenna has two and a half turns of metallic patterns; and for use in a band of 1.2 GHz, the helical antenna has four turns of metallic patterns. The distances between the metallic patterns range approximately 0.6˜3.2 mm. The multiple resonant characteristic is obtained by changing electrical impedance in an equivalent circuit of the helical antenna depending on the distance variations of the metallic patterns. The radiational and directional characteristics of the helical antenna in accordance with the present invention are the same as those of the conventional helical antenna, and the detailed descriptions thereon are omitted accordingly.

Referring to FIGS. 3A to 5B, the stacking process of the helical antenna in accordance with the present invention will now be described.

The plurality of first dielectric sheets 11a of a thickness t1 and the plurality of second dielectric sheets 11b of a thickness t2 are prepared. The partially opened circular loop pattern 22 is formed on bottom surfaces of the first and the second dielectric sheets 11a, 11b to form the first and the second metallic pattern sections 20, 21, respectively. An uppermost dielectric sheet has the partially opened circular loop pattern 22 on the top surface thereof.

The first and second connection elements 23a, 23b are formed by forming a via hole in each of the dielectric sheets 11a, 11b and filling the via hole with a conductive metallic material same as that of the loop patterns 22. Specifically, the first connection elements 23a of length t1 extend through the dielectric sheets 11a in a first dielectric portion 12, and the second connection elements 23b of length t2 extend through the dielectric sheets 11b in a second dielectric portion 13. The via hole is located such that an end portion of the loop pattern 22 is connected to the corresponding connection element 23a or 23b filled therein.

With the exception of the uppermost dielectric sheet 11b, an adhesive layer 30 is applied on the top surfaces of the dielectric sheets 11a, 11b for the stack thereof. The adhesive layer 30 disposed on the electrical contact portion of the connection element 23 is removed by, e.g., masking. Preferably, a barrier 31 is disposed around the connection element 23 for preventing the adhesive material from contacting the connection element 23. Preferably, the barrier 31 has a circular shape and a height of about 0.5˜1.5 mm to shield the connection element 23.

One dielectric sheet 11a or 11b is stacked on a top surface of another dielectric sheet 11b on which the adhesive layer 30 is applied such that an upper end of the connection element 23 is connected with a starting end portion of the partially opened circular loop pattern 22. Preferably, a contact material 32 is coated on one or both of the contact portions of the connection element 23 and the loop pattern 22 in order to facilitate an electrical connection therebetween. The contact material 32 may be a good conductive metal such as copper, silver and gold.

The starting end portion of the partially opened loop pattern 22b formed on the bottom surface of a lowermost dielectric sheet 11a is electrically connected to a line 42 for supplying an electric power to the antenna and connected to a matching circuit 43 for matching the antenna. (see FIG. 6)

FIG. 6 shows a state in which the multi-band helical antenna of the present invention is mounted on a top of a terminal. The line 42 for supplying the electric power to the multi-band helical antenna and the matching circuit 43 for matching the antenna are electrically connected to the helical antenna.

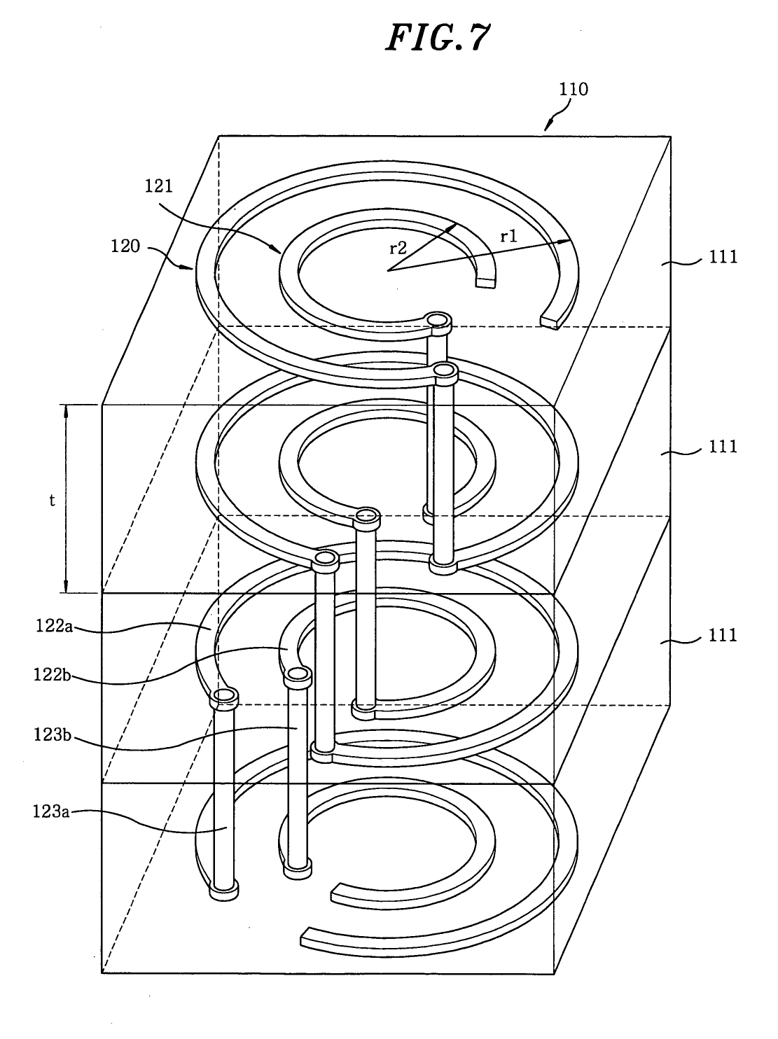

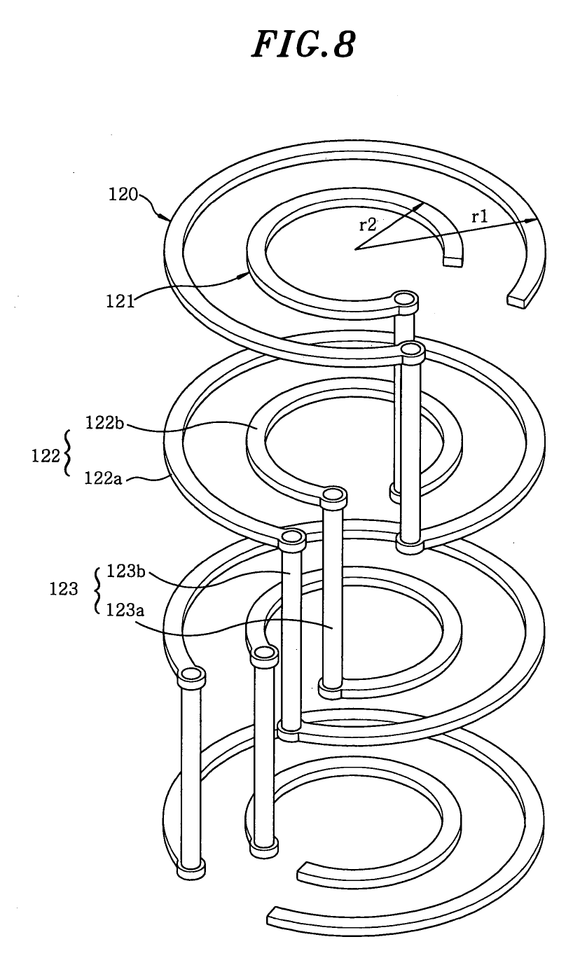

FIG. 7 is a perspective view showing a multi-band helical antenna in accordance with a second preferred embodiment of the present invention, and FIG. 8 is a perspective view showing metallic patterns of the multi-band helical antenna in accordance with the second preferred embodiment of the present invention.

Referring to FIG. 7, the multi-band helical antenna in accordance with the second embodiment of the present invention includes a dielectric body 110 having a rectangular parallelepiped shape, and a first and a second metallic pattern sections 120, 121 comprising a plurality of first and second partially opened circular metallic loop patterns 122a, 122b and a plurality of first and second metallic connection elements 123a, 123b, respectively, which perform helical antenna function.

The dielectric body 110 is constructed by stacking a plurality of dielectric sheets 111 of a predetermined thickness t. The first and the second partially opened circular metallic loop patterns 122a and 122b have radii r1 and r2 different from each other, respectively. The connection elements 123a connect the adjacent loop patterns 122a and the connection elements 123b connect the adjacent loop patterns 123b. In this way, the helical antenna has a dual band resonant characteristic.

As shown in FIG. 8, in the helical antenna in accordance with the second preferred embodiment of the present invention, the first metallic pattern section 120 has the first loop patterns 122a of a first radius r1 and the second metallic pattern section 121 has the second loop patterns 122b of a second radius r2 smaller than r1. The first and the second metallic pattern sections 120 are separated from each other so that the helical antenna has a dual resonant characteristic.

In the above embodiment, for simplification of explanation, two metallic pattern sections having the radii r1, r2, respectively, are shown, but the present invention is not limited thereto. It is appreciated that the helical antenna may have a multiple resonant characteristic by employing three or more pattern sections having different loop pattern radii.

The multiple resonant characteristic is obtained by changing electrical impedance in an equivalent circuit of the helical antenna depending on the radius variations of the metallic patterns. The radiational and directional characteristics of the helical antenna in accordance with the second preferred embodiment of the present invention are the same as those of the conventional helical antenna, and the detailed descriptions thereon are omitted accordingly.

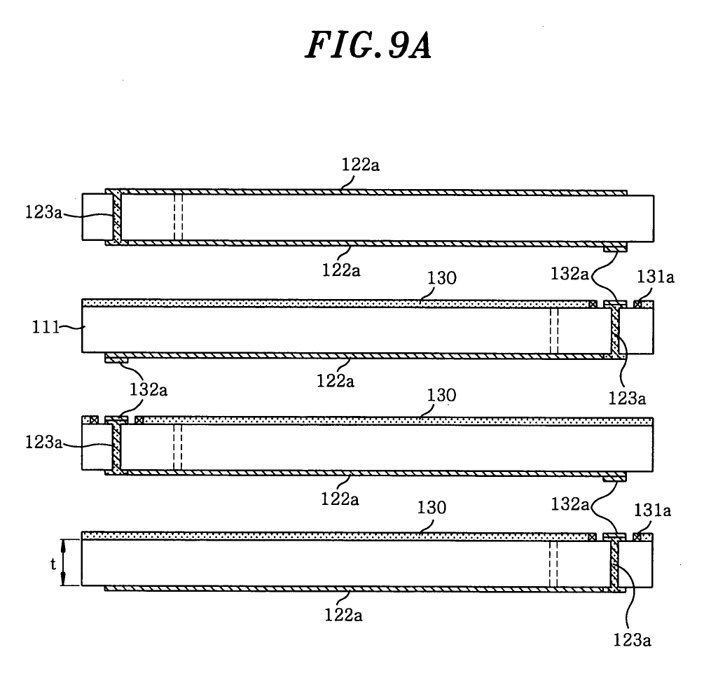

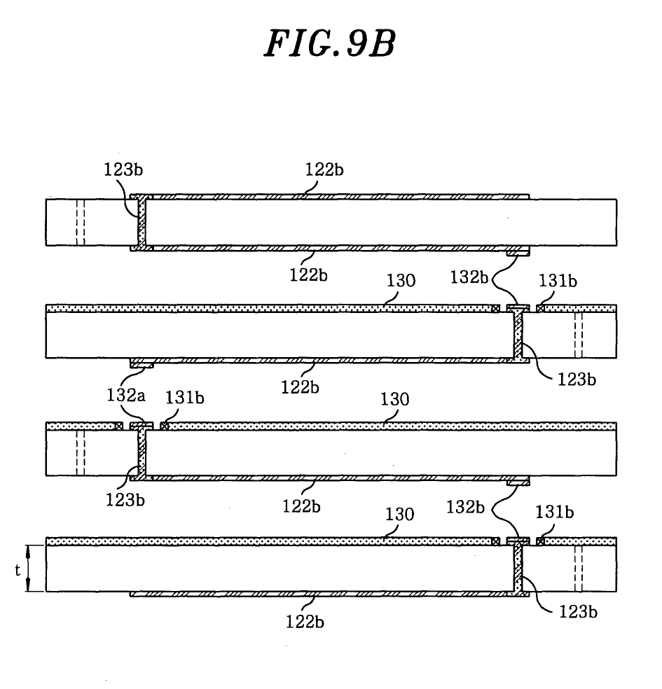

Referring to FIGS. 9A to 11B, the stacking process of the helical antenna in accordance with the second preferred embodiment of the present invention will now be described.

FIG. 9A is an exploded cross-sectional view of the first metallic section 120 and FIG. 9B is an exploded cross-sectional view of the second metallic section 121. They are separately shown for easy understanding thereof.

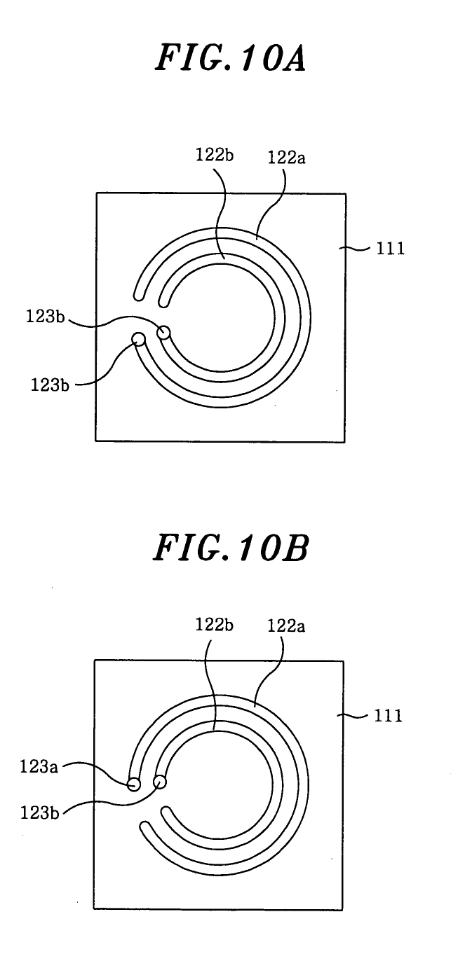

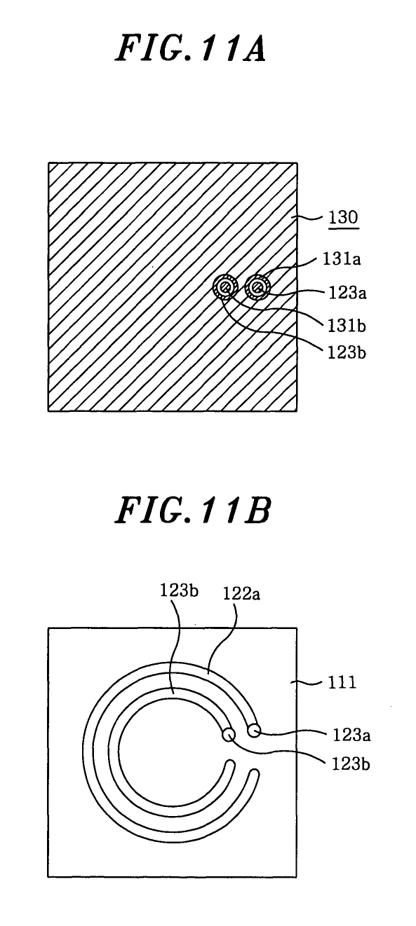

FIGS. 10A and 10B are a top and a bottom views of the uppermost layer of dielectric sheet, respectively, and FIGS. 11A and 11B are a top and a bottom views of one of the intermediate or lower dielectric sheets, respectively.

The plurality of dielectric sheets 111 of a predetermined thickness t is prepared. The first and the second partially opened circular loop patterns 122a, 122b, which have different radii from each other, are formed on the bottom surface of each of the dielectric sheets 111.

Next, the first and second connection elements 123a, 123b are formed by forming at one end portion of each of the first and the second loop patterns 122a, 122b a via hole extending through the dielectric sheets 111 and filing the via hole with a conductive metallic material same as that of the loop patterns 122a, 122b. In this way, the first metallic section 120 comprises the loop patterns 122a of radius r1 and the first connection elements 123a, and the second metallic section 121 comprises the loop patterns 122b of radius r2 and the second connection elements 123b. The connection elements 123a, 123b connect adjacent loop patterns 122a, 122b, respectively.

The uppermost dielectric sheet 111 has the first and the second loop patterns 122a, 122b on the top surface as well as the bottom surface thereof. Further, with the exception of the uppermost dielectric sheet 111, an adhesive layer 130 is applied on the top surfaces of the dielectric sheets 111 for the stack thereof.

The adhesives 130 disposed on an electrical contact portion of the connection elements 123a, 123b are removed by, e.g., masking. Preferably, barriers 131a, 131b are disposed around the connection elements 123a, 123b for preventing the adhesive material from contacting the connection elements 123a, 123b. Preferably, the barriers 131 have a circular shape and a height of about 0.5˜1.5 mm to shield the connection elements 123a, 123b.

One dielectric sheet 111 is stacked on the top surface of another dielectric sheet 111 on which the adhesive layer 130 is applied. At this time, the dielectric sheets 111 are arranged in such a way that upper ends of the connection elements 123a, 123b are connected with starting end portions of the partially opened circular loop patterns 122a, 122b, respectively. Preferably, a contact material 132 is coated on one or both of contact portions of the respective connection elements 123 and the respective loop patterns 122 in order to facilitate the electrical connection therebetween. The contact material 132 may be a good conductive metal such as copper, silver and gold.

The starting end portions of the partially opened circular loop patterns 122 formed on the bottom surface of the lowermost dielectric sheet 111 are electrically connected to lines for supplying electric power to the antenna and connected to matching circuits 43 for matching the antenna, respectively. (see FIG. 6)

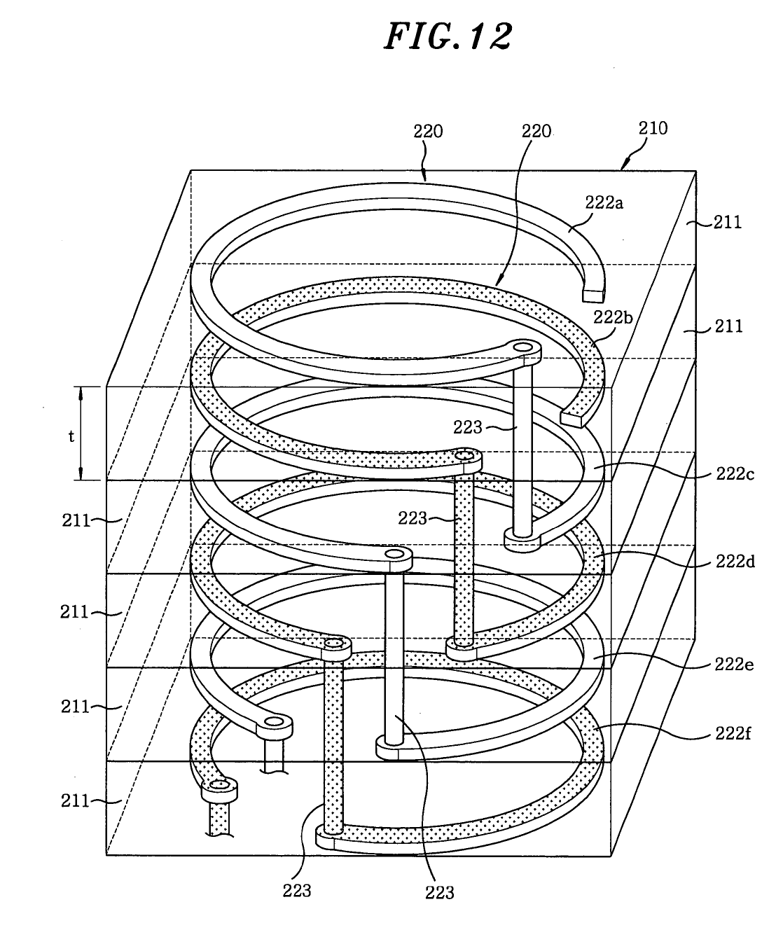

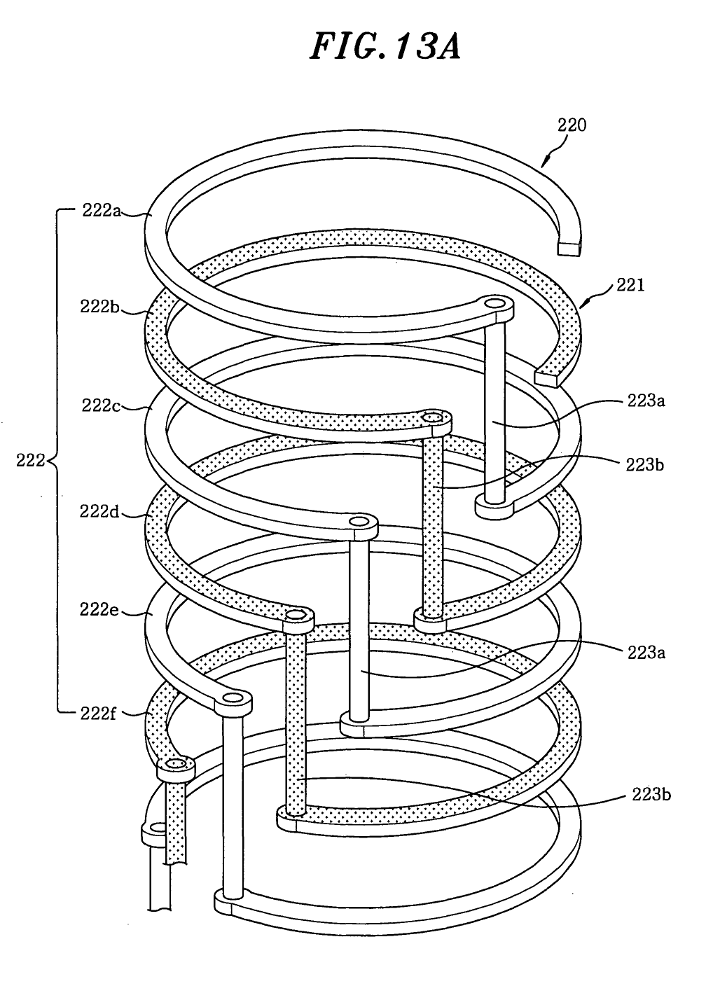

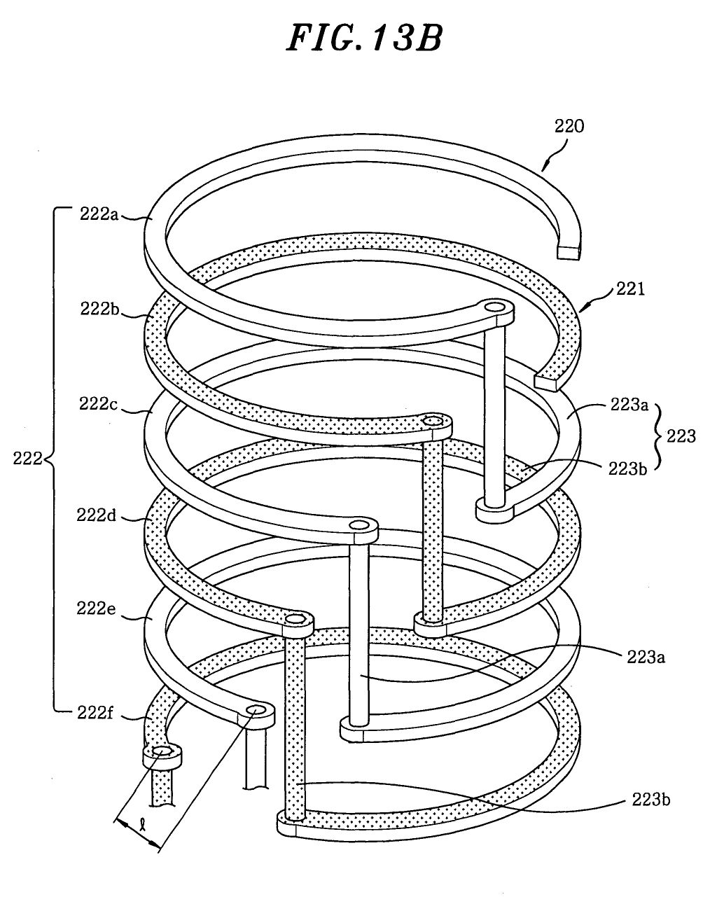

FIG. 12 is a perspective view showing a multi-band helical antenna in accordance with a third embodiment of the present invention, and FIGS. 13A and 13B are perspective views showing metallic patterns of the multi-band helical antenna in accordance with the third embodiment of the present invention, respectively.

Referring to FIGS. 12 to 13B, a multi-band helical antenna in accordance with the third preferred embodiment of the present invention includes a dielectric body 210 of a rectangular parallelepiped shape, and metallic pattern sections 220, 221 comprising a plurality of partially opened circular metallic loop patterns 222 having an opening angle and metallic connection elements 223 which perform helical antenna function.

The dielectric body 210 is constructed by stacking a plurality of dielectric sheets 211 of a predetermined thickness t. The partially opened circular metallic loop patterns 222 of the metallic pattern sections 220, 221 are vertically disposed at regular intervals. The odd numbered loop patterns 222a, 222c, 222e of the first metallic pattern section 220 are in turn connected by connection elements 223a, and the even numbered loop patterns 222b, 222d, 222f of the second metallic pattern section 221 are in turn connected by connection elements 223b. Particularly, the entire length of the first metallic pattern section 220 is different from that of the second metallic pattern section 221 so that the helical antenna has a wide band characteristic in a single band or a dual band resonant characteristic.

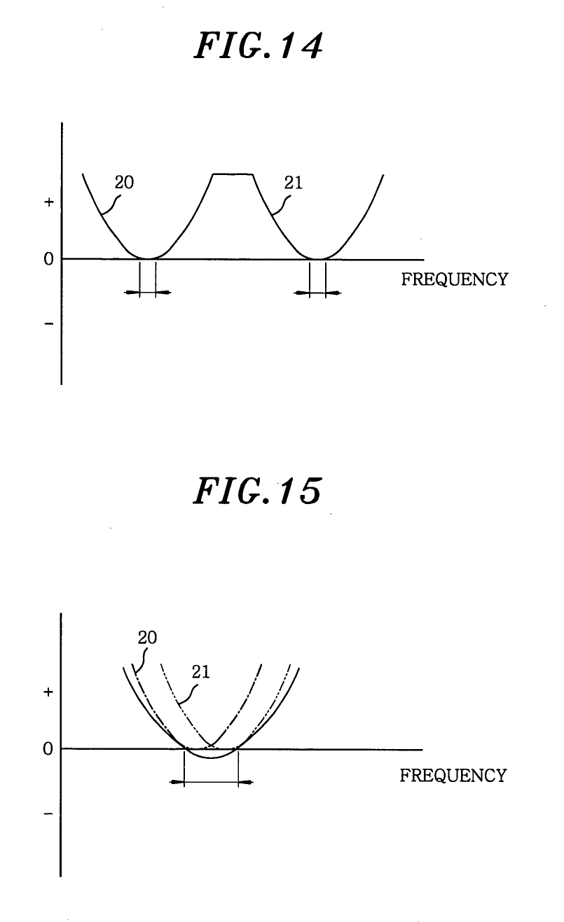

In the helical antenna in accordance with the third embodiment of the present invention, as shown in FIG. 13A, the turns in the first and the second metallic pattern sections 220, 221 are different from each other so that the helical antenna has a dual resonant characteristic and can operate in two different bands. FIG. 14 is a graph showing the dual resonant characteristic of the helical antenna in accordance with the third preferred embodiment of the present invention. Specifically, the resonant frequencies are determined by the resonant lengths of the first metallic pattern section 220 and the second metallic pattern section 221, thereby allowing the helical antenna to operate in dual bands.

In a variation of the third embodiment as shown in FIG. 13B, while the turns in the first and the second metallic pattern sections 220, 221 are the same, the entire lengths thereof are slightly different from each other. FIG. 15 is a graph showing a resonant characteristic in a wide band according to the variation of the present invention. Specifically, the resonant frequency is determined by the resonant length of the first metallic pattern section 220, and the resonance of the second metallic pattern section 221 is generated at a frequency near the resonant frequency of the first metallic pattern section 220. The helical antenna has two adjacent resonant frequency characteristics and exhibits a wider resonant characteristic than in a single metallic pattern section.

In the above embodiment, for simplification of explanation, two metallic pattern sections having different entire lengths are shown; but the present invention is not limited thereto. It is appreciated that the helical antenna may have a multiple resonant characteristic by employing three or more pattern sections having different entire lengths.

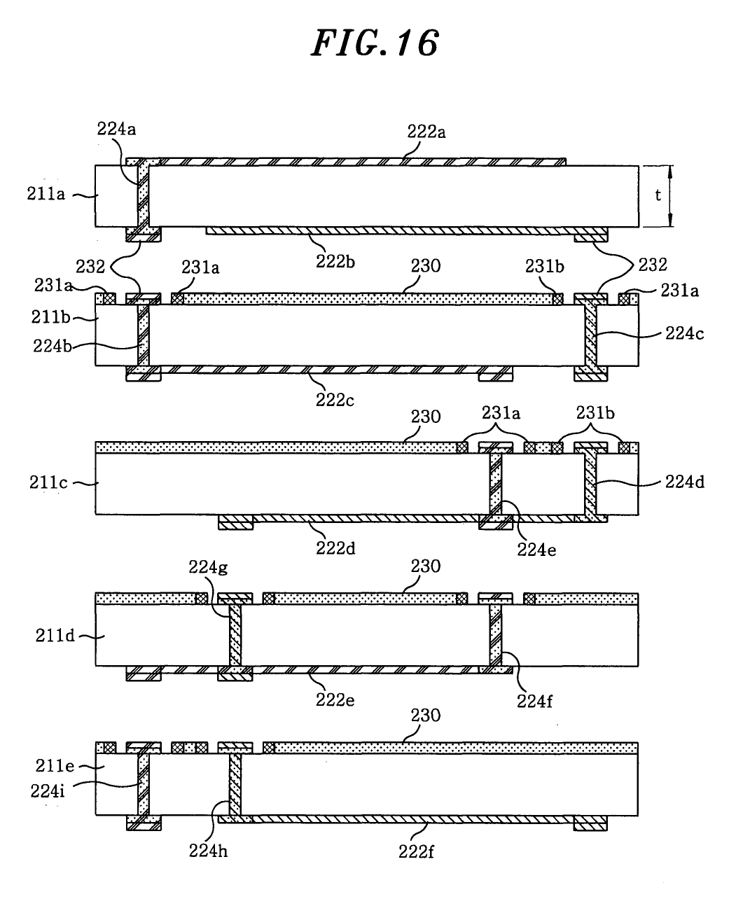

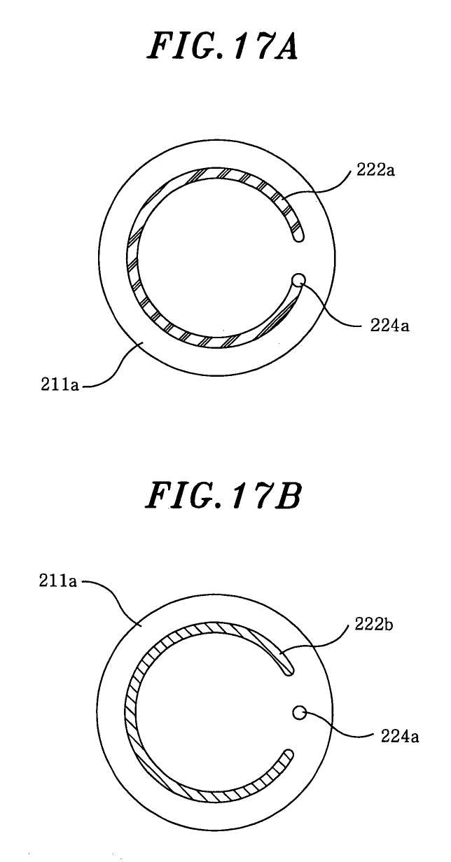

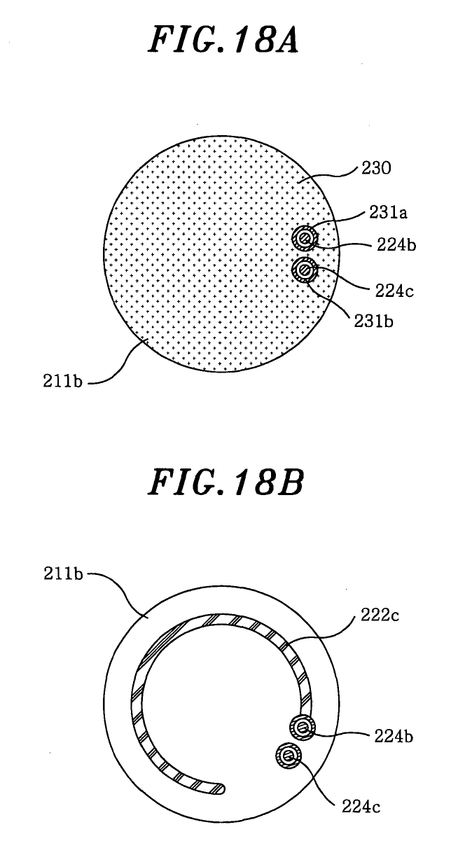

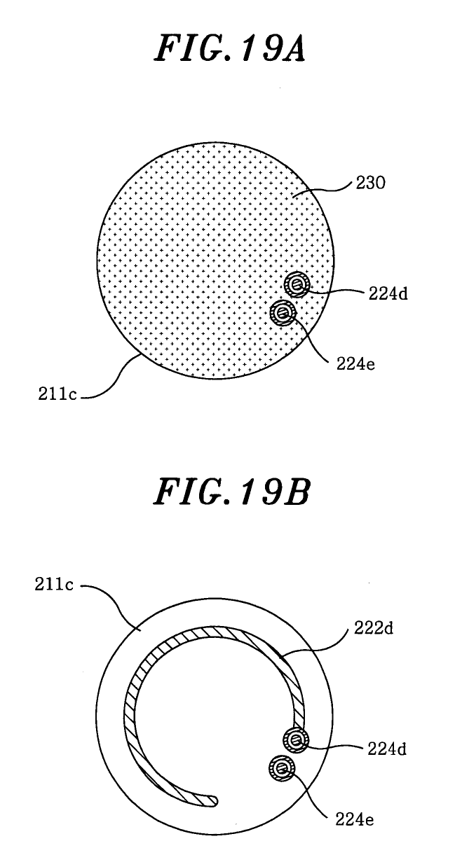

Referring to FIGS. 16 to 19B, the stacking process of the helical antenna in accordance with the third embodiment of the present invention will now be described.

The plurality of dielectric sheets 211 of a predetermined thickness t is prepared. The partially opened circular loop patterns 222 of a predetermined diameter are formed on the bottom surfaces of the dielectric sheets 211, respectively.

The uppermost dielectric sheet 211a has a via hole 224a extending therethrough, the via hole 224a being disposed within the open angle of the loop pattern 222b formed on the bottom surface thereof. The uppermost dielectric sheet 211a has on the top surface thereof the partially opened circular loop pattern 222a which is electrically connected with the connection element filled in the via hole 224a. The uppermost dielectric sheet 211a also has on the bottom surface thereof the partially opened circular loop pattern 222b which is connected with the connection element filled in the via hole 224b. Each of the remaining dielectric sheets 211b, 211c, 211d and so on has on the bottom surface thereof the partially opened circular loop patterns 222c, 222d, 222e and so on.

The dielectric sheet 211b underlying the uppermost 211a has a via hole 224b at the starting end of the loop pattern 222a formed on the bottom surface thereof, the via hole 224b being registered with the via hole 224a and extending through the dielectric sheet 211b. A via hole 224c is also formed in the dielectric sheet 211b within the opening angle of the loop pattern 222c.

Further, the dielectric sheet 211c underlying the dielectric sheet 211b has a via hole 224d at the starting end of the loop pattern 222d formed on the bottom surface thereof, the via hole 224d being registered with the via hole 224b and extending through the dielectric sheet 211c. A via hole 224e is also formed in the dielectric sheet 211c within the opening angle of the loop pattern 222d.

Such via holes 224a to 224e extend through the corresponding dielectric sheets 211, and a conductive metallic material same as that of the loop patterns 222 is filled in the via holes 224a to 224e to form the first and the second connection elements 223a, 223b.

Specifically, the loop pattern 222b formed on the top surface of the dielectric sheet 211a is connected through the connection element filled in the via holes 224a, 224b to the loop pattern 222c formed on the bottom surface of the dielectric sheet 211b to form the first metallic pattern section 220. Further, the loop pattern 222a formed on the bottom surface of the dielectric sheet 211a is connected through the connection element filled in the via holes 224c, 224d to the loop pattern 222d formed on the bottom surface of the dielectric sheets 211c to form the second metallic pattern section 221.

In other words, the odd numbered loop patterns 222b, 222c and 222e are sequentially connected by the first connection elements 223a filled in the via holes 224a, 224b, 224e, 224f and 224i to form the first metallic pattern section 220; and the even numbered loop patterns 22a, 222d and 222f are sequentially connected by the second connection elements 223b filled in the via holes 224c, 224d, 224g and 224h to form the second metallic pattern section 221.

With the exception of the uppermost dielectric sheet 211a, an adhesive layer 230 is applied on the top surfaces of the dielectric sheets 211 for the stack thereof. The adhesive layer 230 disposed on the electrical contact portion of the connection element 223 is removed by, e.g., masking. Preferably, a barrier 231 is disposed around the connection element 223 for preventing the adhesive material from contacting the connection element 223. Preferably, the barrier 231 has a circular shape and a thickness of about 0.5˜1.5 mm to shield the connection element 223.

One dielectric sheet 211 is stacked on the top surface of another dielectric sheet 211 on which the adhesive layer 230 is applied.

Preferably, contact materials 232a, 232b are coated on one or both of the contact portions of the connection element 223 and the loop pattern in order to facilitate the electrical connection therebetween. The contact materials 232a, 232b may be a good conductive metal such as copper, silver and gold.

The partially opened loop pattern 222b formed on the top surface of the uppermost dielectric sheet 11b is maintained opened. The starting portion of the partially opened loop pattern 222 formed on the bottom surface of the lowermost dielectric sheet 211 is electrically connected to the line 42 for supplying an electric power to the antenna and connected to the matching circuit 43 for matching the antenna. (see FIG. 6)

In this embodiment, for simplification of explanation, two metallic pattern sections having different entire lengths are shown, but the present invention is not limited thereto. It is appreciated that the helical antenna may have a multiple resonant characteristic by employing three or mote pattern section having different entire lengths.

While the invention has been shown and described with respect to the preferred embodiments, it will be understood by those skilled in the art that various changes and modifications may be made without departing from the spirit and scope of the invention as defined in the following claims.

What is claimed is:

1. A multi-band helical antenna comprising:
a dielectric body including a plurality of dielectric sheets stacked in a predetermined order; and
at least a first metallic pattern section and a second metallic pattern section provided in the dielectric body, the first metallic pattern including a plurality of first partially opened metallic loop patterns and a plurality of first connection elements connecting the respective adjacent first partially opened metallic loop patterns to form a first spiral structure, and the second metallic pattern section including a plurality of second partially opened metallic loop patterns and a plurality of second connection elements connecting the respective adjacent second partially opened metallic loop patterns to form a second spiral structure, the first and the second metallic pattern sections having different entire lengths.

2. A multi-band helical antenna comprising:
a dielectric body including at least a plurality of first dielectric sheets of a first thickness t1 and a plurality of second dielectric sheets of a second thickness t2 that is different from t1, the dielectric sheets being stacked in a predetermined order; and
at least a first metallic pattern section and a second metallic pattern section provided in the first dielectric sheets and the second dielectric sheets, respectively, the first metallic pattern section including a plurality of first partially opened metallic loop patterns spaced apart from each other by a first distance and a plurality of first connection elements connecting the respective adjacent first metallic loop patterns to form a first spiral structure, and the second metallic pattern section including a plurality of second partially opened metallic loop patterns spaced apart from each other by a second distance different from the first distance and a plurality of second connection elements connecting the respective adjacent second metallic loop patterns to form a second spiral structure.

3. A multi-band helical antenna comprising:
a dielectric body including a plurality of dielectric sheets of a predetermined thickness, the dielectric sheets being stacked in a predetermined order; and
at least a first metallic pattern section and a second metallic pattern section provided in the dielectric body, the first metallic pattern section including a plurality of first partially opened metallic loop patterns having a first radius r1 and a plurality of first connection elements connecting the respective adjacent first partially opened metallic loop patterns to form a first spiral structure, and the second metallic pattern section including a plurality of second partially opened metallic loop patterns having a second radius r2 that is different from r1 and a plurality of second connection elements connecting the respective adjacent second partially opened metallic loop patterns to form a second spiral structure.

4. A multi-band helical antenna comprising:
a dielectric body including a plurality of dielectric sheets of a predetermined thickness, the dielectric sheets being stacked in a predetermined order;
at least a first metallic pattern section and a second metallic pattern section provided in the dielectric body, the first metallic pattern section including a plurality of first partially opened metallic loop patterns having a first entire length l1 and a plurality of first connection elements connecting the respective adjacent first partially opened metallic loop patterns to form a first spiral structure, and the second metallic pattern section including a plurality of second partially opened metallic loop patterns having a second entire length l2 different from l1 and a plurality of second connection elements connecting the respective adjacent second partially opened metallic loop patterns to form a second spiral structure.

5. The antenna of any one of claims 1 to 4, wherein the dielectric body has a rectangular parallelepiped shape.

6. The antenna of any one of claims 1 to 4, wherein each of the dielectric sheets has a via hole and the connection element is provided by filling a conductive material same as that of the metallic loop patterns in the via hole.

7. The antenna of any one of claims 1 to 4, wherein an adhesive layer is provided between the adjacent dielectric sheets.

8. The antenna of claim 7, wherein a barrier is provided on the dielectric sheet around each of the connection elements to prevent the adhesive from contacting the connection elements.

9. The antenna of claim 4, wherein the first and the second metallic loop patterns are alternately disposed in a vertical direction.
